(19) United States
(12) Patent Application Publication
(10) Pub. No.: US 2025/0385018 A1
(43) Pub. Date: Dec. 18, 2025

(54) COMPOSITION COMPRISING DUAL CHEM-HEAT TREATED BRINE SLUDGE WASTE FOR FLEXIBLE AND MOLDABLE MATERIAL AND A PROCESS FOR THE PREPARATION THEREOF

(71) Applicant: COUNCIL OF SCIENTIFIC & INDUSTRIAL RESEARCH, New Delhi (IN)

(72) Inventors: Sarika VERMA, Bhopal (IN); Medha MILI, Bhopal (IN); Mohammed Akram KHAN, Bhopal (IN); Avanish Kumar SRIVASTAVA, Bhopal (IN)

(73) Assignee: COUNCIL OF SCIENTIFIC & INDUSTRIAL RESEARCH, New Delhi (IN)

(21) Appl. No.: 19/236,383

(22) Filed: Jun. 12, 2025

(30) Foreign Application Priority Data
Jun. 13, 2024 (IN) 202411045947

(51) Int. Cl. G21F 1/10; C02F 11/00; C02F 11/13

(52) U.S. Cl. CPC G21F 1/103; C02F 11/008; C02F 11/13

(57) ABSTRACT

The present invention provides a composition for material comprising brine sludge waste and a process for the preparation thereof process for preparation of flexible, functional, and moldable material using advanced Chem-heat treated brine sludge-based composition via solvent-free route for developing samples of various dimensions. The present invention involves developing desired, suitable, and appropriate phases possessing uniform and homogenous matrix in the developed material. Thus, designing molecular moieties in the developed process leads to forming tightly bound three-dimensional structures, strengthening the developed advanced chemically designed material which is cost-effective, non-toxic, highly versatile (can be bent or shaped to fit around curves and corners), durable, easy to install, safe with superior performance and economically feasible advanced flexible, functional and moldable material with a homogeneous uniform matrix using advanced dual chem-heat treated brine sludge based composition for a broad application spectrum.

### CROSS-REFERENCE TO A RELATED APPLICATION

This application claims the benefit of Indian Patent Application No. 202411045947, filed Jun. 13, 2024.

### FIELD OF THE INVENTION

The present invention relates to a composition comprising dual chem-heat treated brine sludge waste for flexible and moldable material and a process for the preparation thereof. In particular, the present invention relates to a composition which utilizes brine sludge waste as an ingredient to produce radiation shielding materials. The material developed in the present invention is immensely useful in the preparation of radiation shielding materials such as partition sheets, industrial, non-industrial, construction and structural applications, diagnostic radiation installations such as diagnostic X-ray and CT scanner rooms in the form of generic shielding sheets, shielding aprons, shielding neck bands, head covers, half aprons, etc. The invention shall help attain the 9^{th} and 12^{th} sustainable development goals of industry, innovation and infrastructure as well as responsible consumption and production respectively.

### BACKGROUND OF THE INVENTION AND DESCRIPTION OF PRIOR ART

Any radiation, either ionizing or non-ionizing, plays a significant role in human life and has a broad application spectrum in versatile sectors such as medical science, health care, military affairs, industrial or agricultural, communication, and daily life. These radiations range from lower energy to higher energies, with variations in frequency which include far infrared, infrared, x-rays, gamma radiation, microwaves and radiofrequency radiation from mobiles. For example, due to its ionizing power, X-rays have been intensively used for medical diagnosis and radiotherapy in X-ray and CT scanner rooms, non-destructive testing and geological exploration, and security zone systems like airports. But, these X-rays have been declared carcinogenic by the International Committee on Radiological Protection (ICRP). Thus, it is urgently required to use these X-rays safely and avoid their hazardous effects. In this aspect, a particular type of special material, namely radiation shielding materials, plays a paramount role. However, the conventional materials are usually hard, non-flexible, and bulky for shielding facilities, thus limiting their versatility in applications.

A candidate material for the preparation of such shielding material is brine sludge. Brine sludge is a waste generated from the chlor-alkali industry for manufacturing caustic soda and chlorine production. During the production of sodium hydroxide and chlorine in the chloral alkali industry, brine sludge waste is formed, which majorly consists of barium sulfate, sodium chloride, magnesium hydroxide, calcium carbonate, clay, and other toxic elements like chromium, copper, zinc, and vanadium and thus, threatening the posing environment. Therefore, there is an urgent need to convert toxic brine sludge waste into anon-toxic system to develop a novel process that aids the development of advanced new versatile materials and ensures complete brine sludge usage globally.

Reference may be made to our co-pending Indian Patent Application number 20220119310, which discloses the designing of raw materials and processing parameters, enabling synergistic and simultaneous chemical reactions among the various reactants of the design mix of the chemical precursor of brine sludge which includes barium sulfate, magnesium hydroxide, calcium carbonate, sodium chloride, silica, aluminum-containing compounds necessary for developing highly efficient shielding phases leading to the homogenous matrix of shielding materials. However, the drawbacks of the process lie in the fact that the processes requires high-temperature sintering during the processing of the raw materials and that is an energy-intensive, time-consuming, and costly process. Also, the developed process does not produce the flexible and moldable product, thus limits to its application spectrum widely. Moreover, the process does not involve designing of appropriate, sequential use of suitable major raw materials in the synergistic and simultaneous way by fine tune processes parameters like polymeric cis-1,4-polyisoprene (2-methyl-1,3-butadiene) or polymerized Acrylonitrile (CH₂═CHCN) and butadiene (CH₂CH—CH═CH₂) sodiumhexamephosphate, bismuth oxide along with brine sludge during the chemical reactions and process parameter. Further, the process does neither uses the advanced synthesis technology like twin roller equipment during the processing of the materials to develop the final product nor involves the formation of unique advanced nano-tailored multi-component, multi-phased like Barium bismuth phosphate, barium metaphosphate Ba(PO₃)₂ etc., homogeneous brine sludge based tailored material using highly effective dual chem-heat treated brine sludge-based composition for further developing advanced flexible, functional and moldable material. Finally, the process does not involve developing highly effective dual chem-heat treated brine sludge-based composition with homogeneous matrix in developed advanced novel flexible, functional and moldable material.

Reference may be made to the article Advanced Flexible And Moldable Material From Novel Brine Sludge And Bamboo-Based Composition and The Process Thereof. Sarika Verma, et al., 2023, which recites the use of the chemical composition of other raw materials like brine sludge, sea water, raw natural rubber, etc. The first drawback of the process is the fact that the developed process does not produce the flexible and moldable product, thus limits to its application spectrum widely. Second, the process does not involves designing appropriate, sequential use of suitable primary raw materials in the synergistic and simultaneous way by fine tune process parameters like polymerized acrylonitrile (CH₂═CHCN) and butadiene (CH₂CH—CH═CH₂) sodiumhexamephosphate, bismuth oxide along with brine sludge during the chemical reactions and process parameter. Third, the process does not involve the formation of unique advanced nano-tailored multi-component, multi-phased like phased like Barium bismuth phosphate, barium metaphosphate Ba(PO₃)₂ etc., homogeneous brine sludge based tailored material for making highly effective dual chem-heat treated brine sludge-based composition for further developing advanced flexible, functional and moldable material. Fourth, the process does not involve developing highly effective dual chem-heat treated brine sludge-based composition having homogeneous matrix in developed advanced novel flexible, functional and moldable material.

Reference may be made to the article Development of Functionalized Nano-precursor Gel Useful for Making Flexible and Moldable Radiation Shielding Material by Sarika Verma, Journal of Materials Engineering and Performance, 26, pages 1018-1025 (2017), wherein nano-size functionalized brine sludge precursor material (FBSPM) containing multi-elemental and multi-shielding phases were synthesized and reacted with polydimethylsiloxane for obtaining tailored hybridinorganic-organic gel which is necessary for making advanced flexible and moldable x-ray radiation shielding material. The first drawback is the fact that the process does not involve designing of appropriate, sequential use of suitable major raw materials in the synergistic and simultaneous way by fine tune process parameters like polymeric cis-1,4-polyisoprene (2-methyl-1,3-butadiene) or polymerized acrylonitrile (CH₂═CHCN) and butadiene (CH₂CH—CH═CH₂) sodium hexametaphosphate, bismuth oxide along with brine sludge during the chemical reactions and process parameter. Second, the process does not involve the formation of unique advanced nano-tailored multi-component, multi-phased phased like Barium bismuth phosphate, barium metaphosphate Ba(PO₃)₂ etc., homogeneous brine sludge based tailored material using highly effective dual chem-heat treated brine sludge-based composition for further developing advanced flexible, functional and moldable x-ray radiation shielding. Third, the process does not use the advanced synthesis technology like twin roller equipment during the processing of the materials to develop the final product as advanced flexible, functional and moldable material Fourth, the process do not involve developing highly effective dual chem-heat treated brine sludge-based composition having homogeneous matrix in developed advanced novel flexible, functional and moldable material.

Reference may be made to U.S. Pat. No. 10,165,713, wherein advanced non-toxic radiation shielding materials utilizing tailored brine sludge to make highly value-added advanced radiation shielding materials have been reported. The first drawback of the said patent is the use of a common matrix for developing radiation shielding material. Second, it requires high-temperature sintering during the processing of the raw materials. Third, it is an energy-intensive, time taking and costly process. Fourth, the developed process does not produce the flexible and moldable product, thus limits to its application spectrum widely. Fourth, the process does not involve designing appropriate, sequential use of suitable major raw materials in the synergistic and simultaneous way by fine tune process parameters like polymeric cis-1,4-polyisoprene (2-methyl-1,3-butadiene) or polymerized acrylonitrile (CH₂═CHCN) and butadiene (CH₂CH—CH—CH₂), bismuth oxide along with brine sludge during the chemical reactions and process parameter. Fifth, the process does not use the advanced synthesis technology like twin roller equipment during the processing of the materials to develop the final product. Sixth, the process does not involve the formation of unique advanced nano-tailored multi-component, multi-phased like barium bismuth phosphate, barium metaphosphate Ba(PO₃)₂ etc., for further developing advanced flexible, functional and moldable material. Seventh, the process does not involve developing highly effective dual chem-heat treated brine sludge-based composition with homogeneous matrix in developed advanced novel flexible, functional and moldable material.

Reference may be made to U.S. Pat. No. 9,890,081B2, wherein total utilization of brine sludge for making functionalized brine sludge valuable material for a broad application spectrum has been done. The main drawbacks of the process are obtaining the material via chemical processing and using a bulk number of pure chemicals and other raw materials. The first drawback is that the process does not involve sequential use of raw materials like polymeric cis-1,4-polyisoprene (2-methyl-1,3-butadiene) or polymerized acrylonitrile (CH₂═CHCN) and butadiene (CH₂CH—CH═CH₂) sodiumhexamephosphate, bismuth oxide along with brine sludge during the chemical reactions and process parameter. Second, the process does not involve the formation of unique advanced nano-tailored multi-component, multi-phased like barium bismuth phosphate, barium metaphosphate Ba(PO₃)₂ etc., homogeneous material for further developing advanced flexible, functional and moldable material. Third, the process does not involve developing highly effective dual chem-heat treated brine sludge-based composition with homogeneous matrix in developed advanced novel flexible, functional and moldable material.

Reference may be made to U.S. Pat. No. 8,728,349 wherein earth and bismuth materials are used, two metal element inorganic compounds and unsaturated organic complexes are adopted, and the in-situ reaction and the compounding with a polymer matrix are carried out. The first drawback of the process is the processes involves the requirement of highly complicated chemical processing of the raw materials. Second, it is an energy-intensive, time taking, and costly process. Third, the process does not involve raw materials like polymeric cis-1,4-polyisoprene (2-methyl-1,3-butadiene) or polymerized acrylonitrile (CH₂═CHCN) and bButadiene (CH₂CH—CH—CH₂) sodiumhexamephosphate, bismuth oxide along with brine sludge during the chemical reactions and process parameter. Fourth, the process does not involve the formation of unique advanced nano-tailored multi-component, multi-phased like barium bismuth phosphate, barium metaphosphate Ba(PO₃)₂ etc., homogeneous radiation shielding material for further developing advanced flexible, functional and moldable material. Fifth, The process does not involve developing highly effective dual chem-heat treated brine sludge-based composition with homogeneous matrix in developed advanced novel flexible, functional and moldable material.

Reference may be made to RU2054439 and RU2028331, wherein a rubber anti-X-ray composite filled with the inorganic rare earth oxides was reported. The first drawback of the process is that the processes involves the poor compatibility between the rare inorganic earth (rare earth oxides) and rubber matrix, wherein it is difficult to obtain finely and homogeneously disperse the fillers into the polymer matrix. Second, the process does not involves polymeric cis-1,4-polyisoprene (2-methyl-1,3-butadiene) or polymerized acrylonitrile (CH₂═CHCN) and butadiene (CH₂CH—CH═CH₂) sodiumhexamephosphate, bismuth oxide along with brine sludge during the chemical reactions and process parameter. Third, the process does not involve the formation of unique advanced nano-tailored multi-component, multi-phased homogeneous material using highly effective dual chem-heat treated brine sludge-based composition for further developing advanced flexible, functional and moldable material. Fourth, the process does not involve developing highly effective dual chem-heat treated brine sludge-based composition with homogeneous matrix in developed advanced novel flexible, functional and material.

Thus, the drawbacks of the hitherto reported prior art may be summarized as follows:
1. Brine sludge threatens environmental safety due to its toxicity and needs to be utilized globally.
2. By a novel process ensuring total usage of toxic brine sludge, crores of rupees can be saved by developing value-added materials otherwise required to maintain brine sludge ponds worldwide.
3. The brine sludge waste has limited application for making, e.g., paver block, bricks, and controlled low-strength materials and other materials like fertilizers only.
4. Few reported processes to highlight using costly, not readily available and processable rare earth elements as raw materials for developing radiation shielding material.
5. None of the reported processes produce a flexible, functional and moldable product, thus limiting its application spectrum widely.
6. The reported processes do not involve the use of other raw materials like bismuth oxide, sodium hexametaphosphate etc. during the chemical reactions.
7. The process does not use advanced synthesis technology like twin roller equipment during the processing of the materials to develop the final product.
8. The process does not involve developing highly effective dual chem-heat treated brine sludge-based composition with homogeneous matrix in developed advanced novel flexible, functional and moldable material.

Thus, keeping in view the drawbacks of the hitherto reported prior arts, the inventors of the present invention realized that there exists a dire need to provide a composition for preparing flexible, moldable radiation shielding materials which utilizes brine sludge waste.

### OBJECTIVES OF THE INVENTION

The main objective of the present invention is therefore to provide a composition comprising dual chem-heat treated brine sludge waste for flexible and moldable material which obviates the drawbacks of the hitherto reported prior art.

Another object of the present invention is to provide a process for the preparation of radiation shielding materials which utilizes brine sludge waste.

Still another object of the present invention is to provide radiation shielding phases possessing uniform and homogenous matrix in the developed material.

Yet another object of the present invention is to provide a brine sludge-based composition comprising brine sludge, SHMP, bismuth oxide either cis-1,4-polyisoprene (2-methyl-1,3-butadiene) or polymerized acrylonitrile (CH₂═CHCN) and butadiene (CH₂CH—CH—CH₂).

Yet another object of the present invention is to solve the disposal problem of toxic brine sludge waste by using it to develop advanced valuable material in the strategic sector and save the environment worldwide.

### SUMMARY OF THE INVENTION

The present invention provides a composition comprising dual chem-heat treated brine sludge waste for preparing flexible and moldable radiation shielding materials. It can be used in broad application spectrum in generic and radiation shielding material via solvent-free chemical reactions. It has multiples uses both in the generic areas and radiation shielding applications such as diagnostic radiation installations such as diagnostic X-ray and CT scanner rooms in the form of Generic shielding sheets, shielding aprons, shielding neck bands, head covers, half aprons, etc.

The present invention provides a novel composition to prepare flexible and moldable material comprising dual chem-heat treated brine sludge waste. Further provided is a process, which involves an appropriate sequential, simultaneous and synergistic chemical reaction of various mineralogical and chemical compounds in an appropriate ratio and process parameters, such as:
i) brine sludge, with
ii) sodium hexametaphosphate, and
iii) bismuth oxide powder
   in order to making unique nano-tailored, multi-component, multi-phased, homogeneous brine sludge based tailored material, which is further mixed in either polymeric cis-1,4-polyisoprene (2-methyl-1,3-butadiene) or polymerized acrylonitrile (CH₂═CHCN) and butadiene (CH₂CH—CH═CH₂) to develop highly effective dual chem-heat treated brine sludge-based composition to develop advanced flexible, functional and moldable material of various desired dimensions. The invention uses the by-products from chlor-alkali industries are used and thus are recycled properly which otherwise cause environmental pollution, for being undercycled and further released into the environment in their toxic forms.

In another embodiment, the present invention provides for a composition of a highly adaptable, superior performance x-ray shielding material of variable dimensions.

In an embodiment, the present invention provides a composition for a highly effective dual chem-heat treated brine sludge-based material comprising 300 to 800 grams brine sludge, 100 to 180 grams SHMP, 120 to 230 grams bismuth oxide, either 120 to 450 grams polymeric cis-1,4-polyisoprene (2-methyl-1,3-butadiene) or 60 to 225 grams polymerized acrylonitrile (CH₂═CHCN) and 60 to 225 grams butadiene (CH₂CH—CH—CH₂).

In another embodiment, the present invention provides a composition for a material, wherein the composition comprises of Brine sludge-based tailored material, polymeric cis-1,4-polyisoprene (2-methyl-1,3-butadiene) or polymerized acrylonitrile (CH₂═CHCN) and butadiene (CH₂CH—CH═CH₂), oil, carbon, sulphur, TMTs, MCB, stearic Acid in % of 72.06, 22.17, 3.32,1.94, 0.14, 0.03, 0.17 0.17 respectively.

In yet another embodiment, the present invention provides a process for the preparation of a flexible and moldable material comprising the following steps:
a) Mixing of 66.11 to 75% of brine sludge with 8.85 to 25% of sodium hexametaphosphate (SHMP)
b) Ball milling of the mixture obtained in a) for 2 to 3 hours.
c) Compacting and heating the prepared material in b) at 900 to 1000° C. for 1 to 1.5 hrs.
d) Grounding of the heat-treated material obtained in c) with 0 to 20.35% of bismuth oxide powder for 2 to 2.5 hrs to obtain an advanced nano-tailored multi-component, multi-phased homogeneous radiation shielding material.
e) Preparing a thin film by rolling 12.95 to 25.62% of polymeric cis-1, 4-polyisoprene or polymerized acrylonitrile and 2-methyl-1,3-butadiene in a twin roller for 10 to 15 minutes.
f) Adding to this film, 71.16 to 80.95% of radiation shielding material obtained in d) and its consequently rolling for 15 to 20 minutes using mixture containing:
   i. 1.66 to 4.44% of oil,
   ii. 1.11 to 2.96% of carbon,
   iii. 0.08 to 0.22% of sulfur,
   iv. 0.03 to 0.15% of tetramethylthiuram,
   v. 0.11 to 0.29% of 2-mercaptobenzothiazole
   vi. 0.11 to 0.29% of stearic acid to obtain the treated material.
g) Cooling of the treated material obtained in f).
h) This treated material was molded and pressed in a compression molding machine in a temperature range of 120-130° C. for 60-90 mins.
i) The above treated material was further demolded to obtain novel flexible, functional and moldable x-ray radiation shielding material.

In an embodiment, the present invention provides a composition comprising dual chem-heat treated brine sludge waste for flexible and moldable material “involves simultaneous and synergistic chemical reactions of various mineralogical and chemical compounds in an appropriate ratio, including brine sludge, bismuth oxide powder, sodium hexametaphosphate for making unique advanced nano-tailored multi-component, multi-phased like Barium bismuth phosphate, barium metaphosphate Ba(PO₃)₂ etc., homogeneous brine sludge based tailored material and further using either polymeric cis-1,4-polyisoprene (2-methyl-1,3-butadiene) or polymerized acrylonitrile (CH₂═CHCN) and butadiene (CH₂CH—CH═CH₂) to form highly effective dual chem-heat treated brine sludge-based composition to obtain the product for having homogeneous in developed advanced novel flexible, functional and moldable material using advanced dual chem-heat treated brine sludge based composition and the process thereof.

In another embodiment, the present invention provides a process comprising simultaneous grinding of brine sludge with sodium hexa metaphosphate (SHMP) in a ball mill etc. for a period of 2 to 3 hours.

In still another embodiment, the present invention provides a process wherein the material so obtained was compacted and heated at 900-1000° C. in a furnace for a duration of 1 to 1.5 h.

In yet another embodiment, the present invention provides a process which comprises the grinding of so obtained heat-treated material along with bismuth oxide powder for a period of 2 to 2.5 hours to obtain advanced nano tailored multi-component, multi-phased like barium bismuth phosphate, barium metaphosphate Ba(PO₃)₂ etc., homogeneous Advanced Brine sludge based tailored material

In still another embodiment, the present invention provides a process wherein either cis-1,4-polyisoprene (2-methyl-1,3-butadiene) or polymerized acrylonitrile (CH₂═CHCN) and butadiene (CH₂CH—CH—CH₂) are taken and rolled for a duration of 10 to 15 minutes in a twin roller at normal temperature in the range of 24 to 28° C. to make a thin film to which advanced nano-tailored multi-component, multi-phased homogeneous brine sludge based tailored material was added, and rolled, optionally oil, carbon, later with sulfur, tetramethyl thiuramdisulphide, each of 2-mercaptobenzothiazoleand stearic acid were thoroughly mixed and rolled for 15 to 20 minutes to obtain the treated material.

In yet another embodiment, the present invention provides a process comprising cooling and completing the final synergistic and simultaneous chemical reactions among various chemical ingredients, which are molded and pressed in a compression molding machine for the duration of 6 to 9 minutes in temperature ranging from 120° C. to 130° C.

In a further embodiment, the present invention provides a composition for dual chem-heat treated brine sludge waste for flexible and moldable radiation shielding material, wherein the said composition comprising:
(a) advanced brine sludge based tailored material;
(b) polymeric cis-1,4-polyisoprene (2-methyl-1,3-butadiene) or polymerized Acrylonitrile (CH₂═CHCN) and Butadiene (CH₂CH—CH═CH₂);
(c) Oil;
(d) Carbon;
(e) Sulphur;
(f) Tetramethyl thiuram disulphide;
(g) 2-mercaptobenzothiazole; and
(h) Stearic Acid;
wherein the ratio of [a]:[b]:[c]:[d]:[e]:[f]:[g]:[h] ranges from 71.16 to 80.95:12.95 to 25.62:1.66 to 4.44:1.11 to 2.96:0.08 to 0.22:0.03 to 0.15:0.11 to 0.29:0.11 to 0.29.

In another embodiment, the present invention provides a composition, wherein the ratio of ratio of [a]:[b]:[c]:[d]:[e]:[f]:[g]:[h] is 71.16:12.95:1.66:1.11:0.08:0.03:0.11:0.11.

In still another embodiment, the present invention provides a composition, wherein the advanced brine sludge-based tailored material comprises:
(i) brine Sludge;
(ii) sodium hexametaphosphate; and
(iii) bismuth Oxide powder;
wherein the ratio of [i]:[ii]:[iii] ranges from 61.54 to 75.00:8.85 to 25.00:0.1 to 20.35.

In yet another embodiment, the present invention provides a composition, wherein the ratio of brine sludge:sodium hexametaphosphate:bismuth oxide powder in the advanced brine sludge based tailored material is 61.54:8.85:0.1.

In still another embodiment, the present invention provides a process for the preparation of dual chem-heat treated brine sludge waste material for flexible and moldable material comprising the following steps:
a) grinding of brine sludge, sodium hexametaphosphate (SHMP) for a period of 2-3 hours and the material so obtained was compacted and heated at 900 to 1000° C. in a furnace for a duration of 1-1.5 hours;
b) grinding the heat-treated material obtained in step (a) along with 120-230g bismuth oxide powder for a period of 2-2.5 hours to obtain advanced brine sludge based tailored material;
c) mixing the advanced brine sludge based tailored material obtained in step (b) with polymeric cis-1,4-polyisoprene (2-methyl-1,3-butadiene) or polymerized acrylonitrile (CH₂═CHCN) and butadiene (CH₂CH—CH═CH₂) and rolling for a duration of 10 to 15 minutes, followed by adding oil, carbon, sulfur, tetramethyl thiuram disulphide,2-mercaptobenzothiazole, stearic acid and mixing thoroughly and rolling for 15 to 20 minutes to obtain a mixture;
d) cooling and molding the mixture obtained in step [c] followed by pressing for a duration of 6 to 9 minutes at a temperature in the range of 120 to 130° C. and demolding to obtain the desired flexible, functional and moldable radiation shielding material

### DETAILED DESCRIPTION OF THE INVENTION

Brine sludge is generated as waste during chlorine and caustic soda production through electrolysis of brine in chlor-alkali manufacturing industry. The brine sludge waste contains such toxic elements as chromium, zinc, copper and vanadium and thus cannot be disposed off directly into the environment as its contents pose a threat to environmental safety. Therefore, in order to recycle the undercycled brine sludge waste, the present invention provides a composition comprising dual chem-heat treated brine sludge waste for flexible and moldable material using solid waste material such as brine sludge waste with sodium hexametaphosphate (SHMP), Bismuth oxide and other additives and chemicals via a solvent free process, performed by maintaining a unique weight ratio of all the appropriate and suitable raw materials. The present invention further provides a chem-heat treated, eco-friendly, cost effective process of preparation that has been developed for the a new composition comprising dual chem-heat treated brine sludge waste producing a flexible and moldable material.

In an aspect of the present invention, in order to prepare a composition comprising dual chem-heat treated brine sludge waste from appropriate mixing, blending and processing of majorly components like brine sludge, SHMP, bismuth oxide either polymeric cis-1,4-polyisoprene (2-methyl-1,3-butadiene) or polymerized acrylonitrile (CH₂═CHCN) and Butadiene (CH₂CH—CH—CH₂).

Accordingly, the present invention provides a novel process for making dual chem-heat treated brine sludge waste for flexible and moldable material, which comprises simultaneous grinding of brine sludge with sodium hexa metaphosphate (SHMP) in a grinding mill, ball mill etc. for a period of 2-3 hours and the material so obtained was then compacted and heated at 900-1000° C. in a furnace for the duration of 1 to 1.5 hour, further the obtained heat treated material was grinded together with bismuth oxide powder for a period of 2 to 2.5 hours to obtain advanced nanotailored multi-component, multi-phased like barium bismuth phosphate, barium metaphosphate Ba(PO₃)₂ etc., homogeneous brine sludge based material and then of either polymericcis-1,4-polyisoprene (2-methyl-1,3-butadiene) or polymerized acrylonitrile (CH₂═CHCN) and butadiene (CH₂CH—CH═CH₂) was taken and rolled for a duration of 10-15 minutes in a twin roller at normal temperature to make a thin film to which advanced nanotailored multi-component, multi-phased homogeneous brine sludge based tailored material was added and rolled optionally using oil, Carbon, later with sulfur, Tetramethyl thiuramdisulphide, each of 2-mercaptobenzothiazoleand stearic acid were thoroughly mixed and rolled for 15 to 20 minutes to obtain the treated material, which was then kept for cooling and completing the final synergistic and simultaneous chemical reactions among various chemical ingredients, which was then molded and pressed in a compression molding machine for the duration of 6-9 minutes at temperature range of 120° C.-130° C. and was further demolded to obtain novel flexible, functional and moldable x-ray material using advanced dual chem-heat treated brine sludge based composition of varying dimensions i.e., shape and size.

In an aspect, the present invention provides a composition of dual chem-heat treated brine sludge waste x-ray shielding material with 96% shielding at 60 kVp x-ray attenuation test and 89% shielding at 90 kVp x-ray attenuation test.

In another aspect of the present invention, the brine sludge waste from chlor-alkali industry is utilized to prepare dual chem-heat treated brine sludge waste-based composition for flexible and moldable material, which can otherwise create environmental pollution if not disposed in an environment friendly manner.

In another aspect, the present invention provides a cost effective way of preparation of dual chem-heat treated brine sludge waste-based composition for flexible and moldable material since they are prepared from extremely economical sources.

### EXAMPLES

The following examples are given by way of illustration only and therefore should not be construed to limit the scope of the present invention in any manner.

### Example 1

A novel process for making a new composition comprising dual chem-heat treated brine sludge waste for flexible and moldable material comprises of simultaneous grinding of brine sludge with sodium sexa metaphosphate (SHMP) in a ball mill etc. for a period of 2 hours. The obtained material was then compacted and heated at 900° C. in a furnace for 1 hour and was grinded to obtain Advanced Brine sludge based tailored material. Further, polymeric cis-1,4-polyisoprene (2-methyl-1,3-butadiene) was taken and rolled for 10 minutes in a twin roller at 24° C. to make a thin film to which advanced Brine sludge based tailored material was added and rolled using 30 g oil, 20 g Carbon, later with 1.5 g sulfur, 1 g Tetramethyl thiuramdisulphide, 2 g each of 2-zercaptobenzothiazole and stearic acid was thoroughly mixed and rolled for 15 minutes to obtain the treated material. It was then kept for cooling and completing the final synergistic and simultaneous chemical reactions among various chemical ingredients. It was then molded and pressed in a compression molding machine for 6 minutes at a temperature 120° C. It was further demolded to obtain black colored novel flexible, functional and material using advanced dual chem-heat treated brine sludge-based composition of dimensions 200 mm×200 mm ×2 mm.

### Example 2

A novel process for making a new composition comprising dual chem-heat treated brine sludge waste for flexible and moldable material comprises of together grinding of brine sludge with sodium hexametaphosphate (SHMP) in a ball mill etc. for a period of 3 hours. The obtained material was then compacted and heated at 950° C. in a furnace for the duration of 1hour and was grinded together with bismuth oxide powder for a period of 2 hours to obtain Advanced Brine sludge based tailored material. Further, polymeric cis-1,4-polyisoprene (2-methyl-1,3-butadiene) was taken and rolled for a duration of 10 minutes in a twin roller at 25° C. to make a thin film to which advanced brine sludge based tailored material was added and rolled using 30 g oil, 20 g carbon, later with 1.5 g sulfur, 1 g tetramethyl thiuramdisulphide, 2 g each of 2-mercaptobenzothiazole and stearic acid were thoroughly mixed and rolled for 15 minutes to obtain the treated material. It was then kept for cooling and completing the final synergistic and simultaneous chemical reactions among various chemical ingredients. It was then molded and pressed in a compression molding machine for the duration of 7 minutes at a temperature 120° C. and was further demolded to obtain black colored novel flexible, functional and moldable material using advanced dual chem-heat treated brine sludge-based composition of dimensions 200 mm×200 mm×3 mm.

### Example 3

A novel process for making a new composition comprising dual chem-heat treated brine sludge waste for flexible and moldable material comprises of together grinding of of brine sludge with sodium hexametaphosphate (SHMP) in a ball mill etc. for a period of 2.5 hours. The obtained material was then compacted and heated at 950° C. in a furnace for the duration of 1 hour and was grinded together with bismuth oxide powder for a period of 2 hours to obtain Advanced Brine sludge based tailored material. Further, polymerized acrylonitrile (CH₂═CHCN) and Butadiene (CH₂CH—CH—CH₂) was taken and rolled for a duration of 10 minutes in a twin roller at 25° C. to make a thin film to which radiation shielding material was added and rolled using 30 g oil, 20 g carbon, later with 1.5 g sulfu 1 g Tetramethyl thiuramdisulphide, 2 g each of 2-mercaptobenzothiazole and stearic acid were thoroughly mixed and rolled for 15 minutes to obtain the treated material. It was then kept for cooling and completing the final synergistic and simultaneous chemical reactions among various chemical ingredients. It was then molded and pressed in a compression molding machine for the duration of 7 minutes at a temperature 125° C. and was further demolded to obtain black colored “novel flexible, functional and moldable material using advanced dual chem-heat treated brine sludge-based composition of dimensions 200 mm×200 mm×3 mm.

### Example 4

A novel process for making a new composition comprising dual chem-heat treated brine sludge waste for flexible and moldable material comprises of together grinding of brine sludge with sodium hexametaphosphate (SHMP) in a ball mill etc. for a period of 3 hours. The obtained material was then compacted and heated at 1000° C. in a furnace for the duration of 1 hour and was grinded together with bismuth oxide powder for a period of 2 hours to obtain Advanced Brine sludge-based tailored material. Further, polymeric cis-1,4-polyisoprene (2-methyl-1,3-butadiene) was taken and rolled for a duration of 10 minutes in a twin roller at 28° C. to make a thin film to which advanced brine sludge-based tailored material was added and rolled using 30 g oil, 20 g carbon, later with 1.5 g sulfur, 1 g tetramethyl thiuramdisulphide, 2 g each of 2-mercaptobenzothiazole and stearic acid were thoroughly mixed and rolled for 15 minutes to obtain the treated material. It was then kept for cooling and completing the final synergistic and simultaneous chemical reactions among various chemical ingredients. It was then molded and pressed in a compression molding machine for the duration of 7 minutes at a temperature 130° C. and was further demolded to obtain black colored “novel flexible, functional and moldable material using advanced dual chem-heat treated brine sludge-based composition of dimensions 200 mm×200 mm×5 mm.

### Example 5

A novel process for making a new composition comprising dual chem-heat treated brine sludge waste for flexible and moldable material comprises of together grinding of of brine sludge with sodium hexa metaphosphate (SHMP) in a ball mill etc. for a period of 3 hours. The obtained material was then compacted and heated at 1000° C. in a furnace for the duration of 2.5 hour and was grinded together with bismuth oxide powder for a period of 2.5 hours to obtain Advanced Brine Sludge based tailored material. Further, polymerized acrylonitrile (CH₂═CHCN) and butadiene (CH₂CH—CH═CH₂) was taken and rolled for a duration of 10 minutes in a twin roller at 28° C. to make a thin film to which Advanced Brine sludge based tailored material was added and rolled using 30 g oil, 20 g carbon, later with 1.5 g sulfur, 1 g tetramethyl thiuramdisulphide, 2g each of 2-mercaptobenzothiazole and stearic acid were thoroughly mixed and rolled for 15 minutes to obtain the treated material. It was then kept for cooling and completing the final synergistic and simultaneous chemical reactions among various chemical ingredients. It was then molded and pressed in a compression molding machine for the duration of 6 minutes at a temperature 120° C. It was further demolded to obtain black colored “novel flexible, functional and moldable material using advanced dual chem-heat treated brine sludge-based composition of dimensions 200 mm×200 mm×5 mm.

### Example 6

A novel process for making a new composition comprising dual chem-heat treated brine sludge waste for flexible and moldable material comprises of together grinding of brine sludge with sodium hexa metaphosphate (SHMP) in a ball mill etc. for a period of 2 hours. The obtained material was then compacted and heated at 1000° C. in a furnace for the duration of 2 hour and was grinded together with bismuth oxide powder for a period of 2.5 hours to obtain advanced brine sludge based tailored material. Further, polymerized acrylonitrile (CH₂═CHCN) and butadiene (CH₂CH—CH═CH₂) was taken and rolled for a duration of 10 minutes in a twin roller at 25° C. to make a thin film to which advanced brine sludge based tailored material was added and rolled using 60 g oil, 35 g Carbon, later with 2.5 g sulfur, 0.5 g tetramethyl thiuramdisulphide, 3g each of 2-mercaptobenzothiazole and stearic acid was thoroughly mixed and rolled for 15 minutes to obtain the treated material. It was then kept for cooling and completing the final synergistical and simultaneous chemical reactions among various chemical ingredients. It was then molded and pressed in a compression molding machine for the duration of 9 minutes at a temperature of 120° C. and was further demolded to obtain black colored novel flexible, functional and moldable material using advanced dual chem-heat treated brine sludge-based composition of dimensions 150 mm×150 mm×5 mm.

Table 1 (a) and 1(b) depict below the chemical composition and of materials comprising dual chem-heat treated brine sludge waste and a process for the preparation thereof and Table 2 depicts the characteristics of composition for material comprising dual chem-heat treated brine sludge waste

TABLE 1(a)
Different types of raw materials are used for the production
of developed samples in the aforementioned examples

| | | polymeric cis- | | | | | | |
|---|---|---|---|---|---|---|---|---|
| | | 1,4-polyisoprene | | | | | | |
| | | (2-methyl-1,3- | | | | | | |
| | | butadiene) or | | | | | | |
| | Brine | polymerized | | | | | | |
| | sludge | Acrylonitrile | | | | | | |
| | based | (CH₂═CHCN) | | | | | | |
| | tailored | and Butadiene | | | | | | Stearic |
| Example | material | (CH₂CH—CH═CH₂) | Oil | Carbon | Sulphur | TMTs | MCB | Acid |
| No. | (in %) | (in %) | (in %) | (in %) | (in %) | (in %) | (in %) | (in %) |
| 1 | 73.91 | 17.74 | 4.44 | 2.96 | 0.22 | 0.15 | 0.29 | 0.29 |
| 2 | 78.41 | 15.69 | 3.14 | 2.09 | 0.15 | 0.10 | 0.21 | 0.21 |
| 3 | 80.95 | 12.95 | 3.24 | 2.16 | 0.16 | 0.11 | 0.21 | 0.21 |
| 4 | 71.16 | 25.62 | 1.71 | 1.14 | 0.09 | 0.06 | 0.11 | 0.11 |
| 5 | 71.96 | 24.91 | 1.66 | 1.11 | 0.08 | 0.06 | 0.11 | 0.11 |
| 6 | 72.06 | 22.17 | 3.32 | 1.94 | 0.14 | 0.03 | 0.17 | 0.17 |

TABLE 1(b)
Different types of raw materials used for the formation
of Advanced brine sludge-based tailored material

| | | | Bismuth Oxide |
|---|---|---|---|
| Example | Brine Sludge | SHMP | Powder |
| No. | (in %) | (in %) | (in %) |
| 1 | 75 | 25 | 0 |
| 2 | 61.54 | 18.46 | 20 |
| 3 | 70.59 | 15.29 | 14.12 |
| 4 | 72.17 | 15.46 | 12.37 |
| 5 | 66.11 | 14.88 | 19.01 |
| 6 | 70.80 | 8.85 | 20.35 |

Various samples were prepared and studied for the characteristics of the developed material comprising dual chem-heat treated brine sludge waste material such as density, elongation, hardness, and % X-ray attenuation test at 60 kVp and 90 kVp respectively. The density of samples ranges from 2.2 to 3.0 g/cm³. The Maximum elongation reaches to 920%. The Hardness of the developed samples is from 50-62 A. Further, at % X-ray attenuation test at 60 kVp is found to be in the range of 75 to 96% whereas % X-ray attenuation test at 90 kVp is found to be in the range of 72 to 89%. It confirms the attenuation characteristics are directly proportional to the percentage of Brine sludge present in the developed sample.

TABLE 2
Depicts the Characteristics of Composition For Material
Comprising Dual Chem-Heat Treated Brine Sludge Waste

| | | | | % X-ray | % X-ray |
|---|---|---|---|---|---|
| | | | | attenuation | attenuation |
| Example | Density | Elongation | Hardness | test at | test at |
| no. | (g/cm³) | (%) | (A) | 60 kVp | 90 kVp |
| 1 | 2.2 | 850 | 50 | 75 | 72 |
| 2 | 2.85 | 900 | 55 | 92 | 85 |
| 3 | 2.85 | 910 | 54 | 91 | 84 |
| 4 | 3.0 | 920 | 54 | 95 | 89 |
| 5 | 2.95 | 850 | 60 | 95 | 88 |
| 6 | 3.0 | 800 | 62 | 96 | 89 |

### ADVANTAGES OF THE INVENTION

The invention aims to develop flexible, functional and moldable radiation shielding materials from a waste such as brine sludge.
Solventless/free chemical reaction to develop a novel brine sludge-based composition for advanced flexible and moldable material.
Solves the disposal problem of toxic brine sludge waste and makes the environment cleaner, greener, and safer.
Provides a simple, scalable, deployable and cost-effective process enabling widespread utilization of developed advanced flexible, functional and moldable material with a homogeneous uniform matrix for a broad application spectrum.

We claim:

1. A composition for dual chem-heat treated brine sludge waste for flexible and moldable radiation shielding material, wherein the composition comprising:
(a) advanced brine sludge based tailored material;
(b) polymeric cis-1,4-polyisoprene (2-methyl-1,3-butadiene) or polymerized Acrylonitrile (CH2═CHCN) and Butadiene (CH2CH—CH—CH2);
(c) oil;
(d) carbon;
(e) sulphur;
(f) tetramethyl thiuram disulphide;
(g) 2-mercaptobenzothiazole; and
(h) Stearic Acid;
wherein the ratio of [a]:[b]:[c]:[d]:[e]:[f]:[g]:[h] ranges from 71.16 to 80.95:12.95 to 25.62:1.66 to 4.44:1.11 to 2.96:0.08 to 0.22:0.03 to 0.15:0.11 to 0.29:0.11 to 0.29.

2. The composition as claimed in claim 1, wherein the ratio of ratio of [a]:[b]:[c]:[d]:[e]:[f]:[g]:[h] is 71.16:25.62:1.71:1.14:0.09:0.06:0.11:0.11.

3. The composition as claimed in claim 1, wherein the advanced brine sludge-based tailored material comprises:
(i) brine Sludge;
(ii) sodium hexametaphosphate; and
(iii) bismuth oxide powder;
wherein the ratio of [i]:[ii]:[iii] ranges from 61.54 to 75.00:8.85 to 25.00:0.1 to 20.35.

4. The composition as claimed in claim 1, wherein the ratio of Brine Sludge:Sodium hexametaphosphate:Bismuth Oxide powder in the advanced brine sludge based tailored material is 61.54:8.85:0.1.

5. A process for the preparation of dual chem-heat treated brine sludge waste material for flexible and moldable material comprising the following steps:
a) grinding of brine sludge, Sodium Hexametaphosphate (SHMP) for a period of 2-3 hours to obtain a material followed by compacting and heating the obtained material at 900 to 1000° C. in a furnace for a duration of 1-1.5 hours to obtain heat-treated material;
b) grinding the heat-treated material obtained in step (a) along with 120-230 g bismuth oxide powder for a period of 2-2.5 hours to obtain advanced brine sludge based tailored material;
c) mixing the advanced brine sludge based tailored material obtained in step (b) with polymeric cis-1,4-polyisoprene (2-methyl-1,3-butadiene) or polymerized acrylonitrile (CH₂═CHCN) and butadiene (CH₂CH—CH—CH₂) and rolling for a duration of 10 to 15 minutes, followed by adding oil, carbon, sulfur, tetramethyl thiuram disulphide,2-mercaptobenzothiazole, stearic acid and mixing thoroughly and rolling for 15 to 20 minutes to obtain a mixture;
d) cooling and molding the mixture obtained in step [c] followed by pressing for a duration of 6 to 9 minutes at a temperature in the range of 120 to 130° C. and demolding to obtain the desired flexible, functional and moldable radiation shielding material.
